(19) United States
(12) Patent Application Publication
(10) Pub. No.: US 2014/0183792 A1
(43) Pub. Date: Jul. 3, 2014

(54) METHOD AND APPARATUS FOR FREEZE-FORM EXTRUSION FABRICATION OF FUNCTIONALLY GRADIENT COMPOSITE PARTS

(71) Applicants: Ming C. Leu, Rolla, MO (US); Gregory E. Hilmas, Rolla, MO (US); Catalin Roman, Roman (RO)

(72) Inventors: Ming C. Leu, Rolla, MO (US); Gregory E. Hilmas, Rolla, MO (US); Catalin Roman, Roman (RO)

(21) Appl. No.: 13/729,691

(22) Filed: Dec. 28, 2012

(51) Int. Cl. B29C 47/00

(52) U.S. Cl. CPC B29C 47/0071
USPC 264/401

(57) ABSTRACT

This novel technology relates to a freeze-form extrusion fabrication process for fabricating three-dimensional functionally gradient composite parts by extruding and mixing multiple aqueous pastes prior to depositing and freezing the mixed paste, layer by layer, using a computer controlled multi-extruder apparatus. Various aqueous pastes with low organic binder contents are first prepared. The extrusion of each different paste is coordinated through computer control, which mixes the pastes in any desired proportions prior to extrusion through and deposition according to a pre-programmed deposition path for each layer. The mixed paste is frozen immediately after deposition. A heating jacket may be used to prevent the pastes from freezing prior to deposition. The layer-by-layer fabrication process continues until an entire part has been fabricated.

### CROSS-REFERENCE TO RELATED APPLICATIONS

This patent application claims priority to co-pending U.S. provisional patent application Ser. No. 61/631,227, filed on Dec. 28, 2011.

### TECHNICAL FIELD

The present novel technology relates generally to the field of material science, and, more particularly, to a freeze-form extrusion fabrication process using a computer controlled multi-extruder with mixing subsystems to fabricate “green” composite parts from multiple aqueous pastes made of different raw materials according to the pre-specified geometry and material composition to yield a three-dimensional part.

### BACKGROUND

There is an increasing need for complex three-dimensional (3D) parts having high-performance mechanical and thermal properties. One attempt at meeting this need has been to combine unique properties of different materials to yield 3D parts of functionally gradient properties. Due to the fact that some materials have desirable properties in some aspects (such as resistance to high temperatures) but less desirable properties in other aspects (such as toughness and/or shock absorption), attempts have been made to combine and grade different materials to make parts for use under critical or extreme service conditions. These attempts have met with limited success.

Recently, several freeform fabrication techniques have been developed and engaged to fabricate 3D ceramic components, including fused deposition of ceramics, fused deposition modeling, extrusion freeform fabrication, 3-D printing, chemical liquid deposition, selective laser sintering, selective laser melting, shape deposition manufacturing, and robocasting. All of these techniques involve adding ceramic materials layer by layer. Post-processing is usually required to provide mechanical strength to the fabricated ceramic part, rendering it useful for industrial applications.

One prior art technique for freeform fabrication involves the incorporation of a material advance mechanism having a pair of power-driven rollers with a nip to grip and advance a continuous strand of material and dispense the discharged material onto a base member to fabricate a three-dimensional object. A related approach uses a material deposition head for dispensing continuous or intermittent strands of food compositions in fluent states onto a base member.

The extrusion freeform fabrication (EFF) process utilizes extruded organic based pastes to produce 3D components from functionally graded materials, such as ceramic oxides graded to inconel or stainless steel. Robocasting is an aqueous based extrusion technique that has been used to produce parts from different types of materials including oxides and non-oxides, biomaterials, as well as functionally graded materials such as Si₃N₄ graded to W. Both the EFF and robocasting processes are room-temperature freeform fabrication techniques. Due to the intrinsic property of the slurries or pastes used by these techniques, substantial deformation of large parts under their own weight continues to plague the fabrication process. Thus, there remains a need for an improved technique for fabricating functionally graded complex 3D parts. The present novel technology addresses this need.

### SUMMARY

The present novel technology relates to a method and apparatus for fabricating functionally graded complex 3D parts. One object of the present novel technology is to provide an improved technique for fabricating functionally graded complex 3D parts. Related objects and advantages of the present novel technology will be apparent from the following description.

### BRIEF DESCRIPTION OF THE DRAWINGS

FIG. 1 is a perspective view showing the inventive multi-extruder machine for making three-dimensional functionally gradient composite parts.

FIG. 2 is a cross-sectional view showing three syringes for different pastes, a static mixer and a nozzle.

FIG. 3 is a view for the extrusion mechanism showing three linear positioners and three load cells.

FIG. 4 is a perspective view of a subassembly of the mixing station showing the mounting plate and housing for the syringes.

FIG. 5 is another perspective view of the extrusion mechanism showing the brackets that hold the linear positioners and the holding plates for the syringes.

FIG. 6 shows the mounting plate that includes the shoulder bracket, the spacers and the mounting bracket for housing.

FIG. 7 shows the mounting plate with guiding holes and the brackets used to increase the plate's resistance.

FIG. 8 shows the concept of fabricating a part with gradient materials using the FEF process.

FIG. 9 shows control of paste composition by the triple-extruder FEF machine.

FIG. 10 shows the effect of methylcell on the rheological behavior of the Al₂O₃ Paste with 45% solid loading.

FIG. 11 show the constructed triple-extruder FEF machine with a heat jacket for the housing.

FIG. 12 shows the FEF control system schematic.

FIG. 13 shows the fabrication of a cylindrical part with discrete material gradients.

FIG. 14A graphically displys the control signal voltage as a function of time profile.

FIG. 14B graphically displays the control signal velocity as a function of time profile.

FIG. 14C graphically displays the measured extrusion force as a function of time profile.

FIG. 14D graphically displays the extruder position as a function of time profile.

FIG. 15 shows a composite test part with varying alumina and zirconia compositions produced by the FEF system.

### DETAILED DESCRIPTION

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

The present novel technology relates to a method and apparatus for mixing multiple aqueous pastes of different materials at predetermined proportions, and subsequently depositing the mixed paste layer-by-layer under computer control inside a freezing chamber to fabricate 3D composite parts having functionally graded properties. This technique allows for building 3D parts of complex geometry from multiple source materials that can be graded as desired. The novel technique addresses the issue of parts deforming under their own weight by freezing and solidifying extruded paste immediately upon deposition. This is done by extruding aqueous-based pastes at temperatures lower than the freezing point of the aqueous medium. This technique has been successfully demonstrated for fabrication of parts using monolithic material such as Al₂O₃, ZrB₂ and 13-93 bioglasses.

The present novel technology provides a process and tool for fabricating 3D composite parts with functionally graded materials layer-by-layer by using a computer controlled multi-extruder apparatus to fabricate 3D composite parts from multiple aqueous pastes, each paste respectively incorporating different raw or source materials. This novel technology enables producing functionally graded components with desired mechanical, thermal and other like properties. Example applications include leading edges for hypersonic vehicles, missile nose cones, and nozzle throat inserts for spacecraft propulsion systems. Advanced aerospace systems such as hypersonic air vehicles are required to operate at extremely high flight speeds and under extremely high temperatures. The desired hypersonic speed will result in high heat fluxes at the leading and trailing edges, requiring thermal protection systems that can withstand very high temperatures. In another example, the desire for increased propulsion leads to extremely high temperature environments in which components such as combustors and propulsion nozzles must survive. Ultra-High Temperature Ceramics (UHTCs) such as HfC, ZrC, TaC, ZrB₂, HfB₂, and HfN exhibit very good refractory properties, high melting points, reasonable oxidation and thermal shock resistance, low coefficient of thermal expansion, and good creep and fatigue properties. However, the use of monolithic UHTCs in the extreme environments has some disadvantages. First, monolithic UHTCs do not possess the thermal shock resistance needed to survive the high temperature gradients due to the extreme heating cycles required for high-performance propulsion systems. Second, UHTCs cannot be readily attached to the underlying substructure (metals). A functionally graded material architecture of UHTC-refractory metal composite can minimize thermal stresses in applications that involve extremely high temperatures and high heat flux.

The present novel technology relates to the process and apparatus for fabricating 3D composite parts with functionally gradient properties by mixing different materials prepared in the form of aqueous pastes and depositing the mixed pastes layer by layer. The novel process typically uses aqueous pastes with very low organic binder content (typically, between 2-4 volume percent). Unlike the robocasting process, the novel process builds a green part in a freezing chamber with a subfreezing temperature so as to rapidly freeze the paste during the “green” part fabrication process. The green part is fabricated using a triple extruder machine in a layer-by-layer manner. The fabricated part is then freeze-dried and the binder is removed through a burnout process. The calcined or “brown” part is then sintered to obtain a final part.

The novel freeze-form extrusion fabrication process works in an environment whose temperature can be controlled by, for example, controlling the release of liquefied gases such as liquid nitrogen to lower the temperature of the environment. The idea is that under a subfreezing temperature environment deposited paste can be frozen immediately after it exits from the nozzle to support the next layer deposited atop of the current layer.

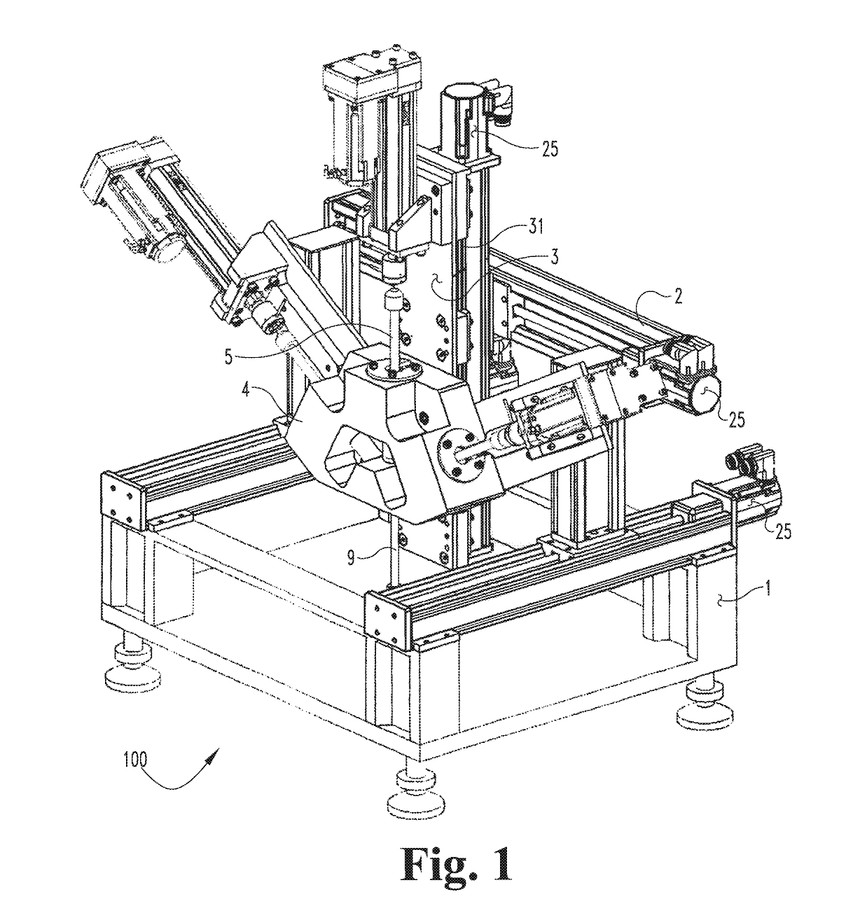

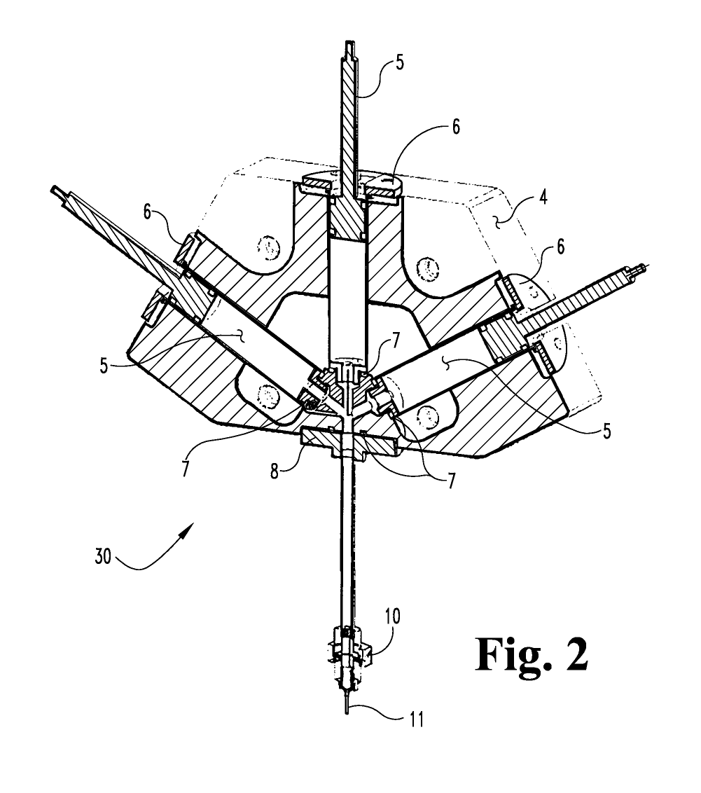

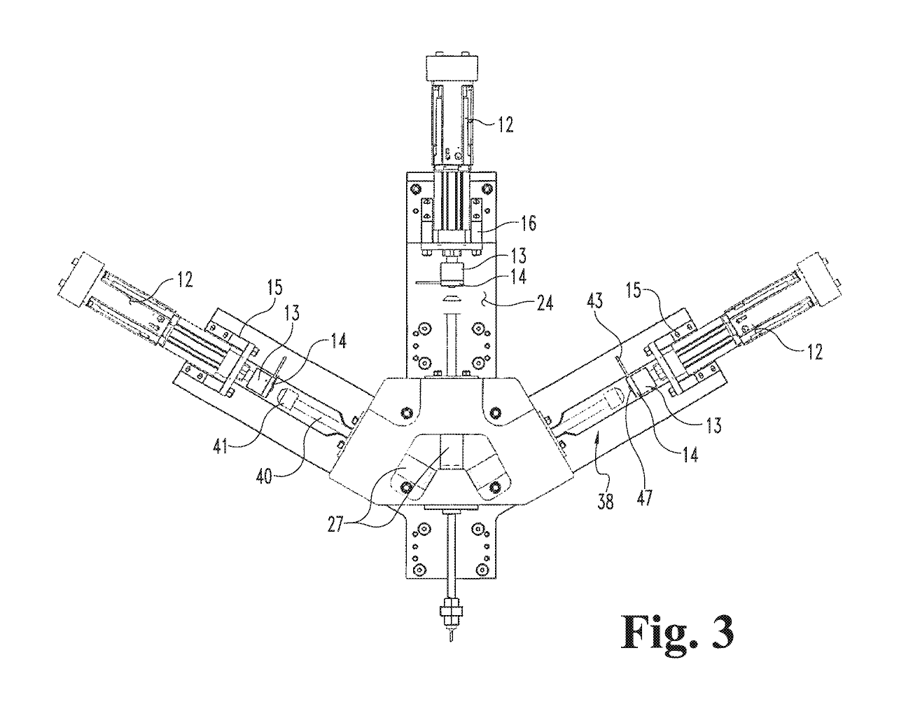

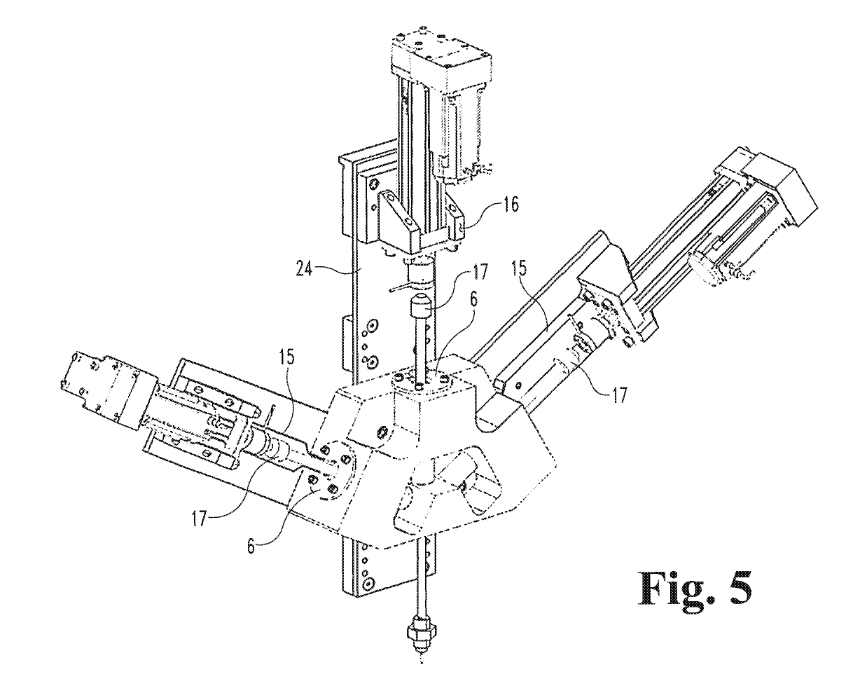

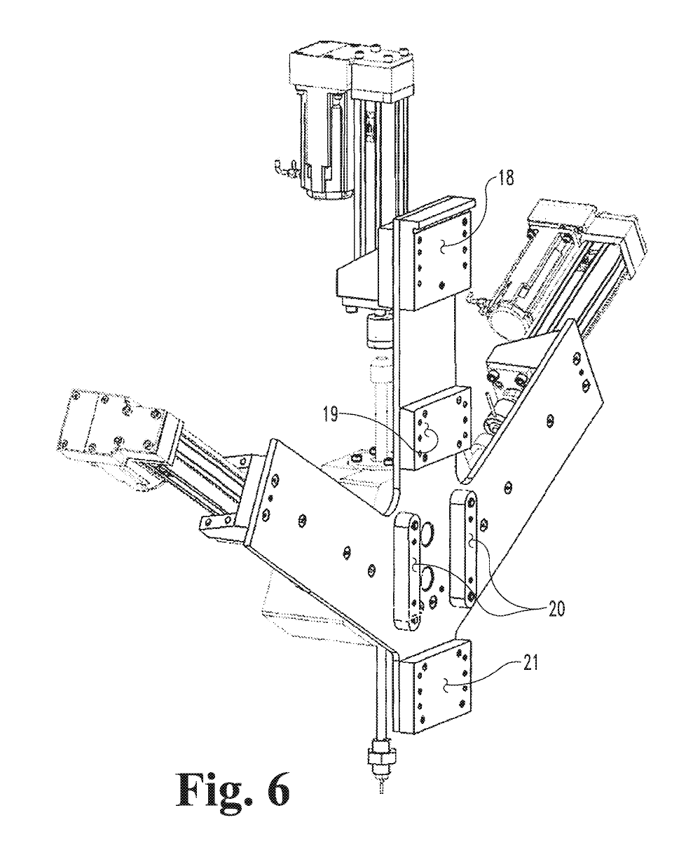

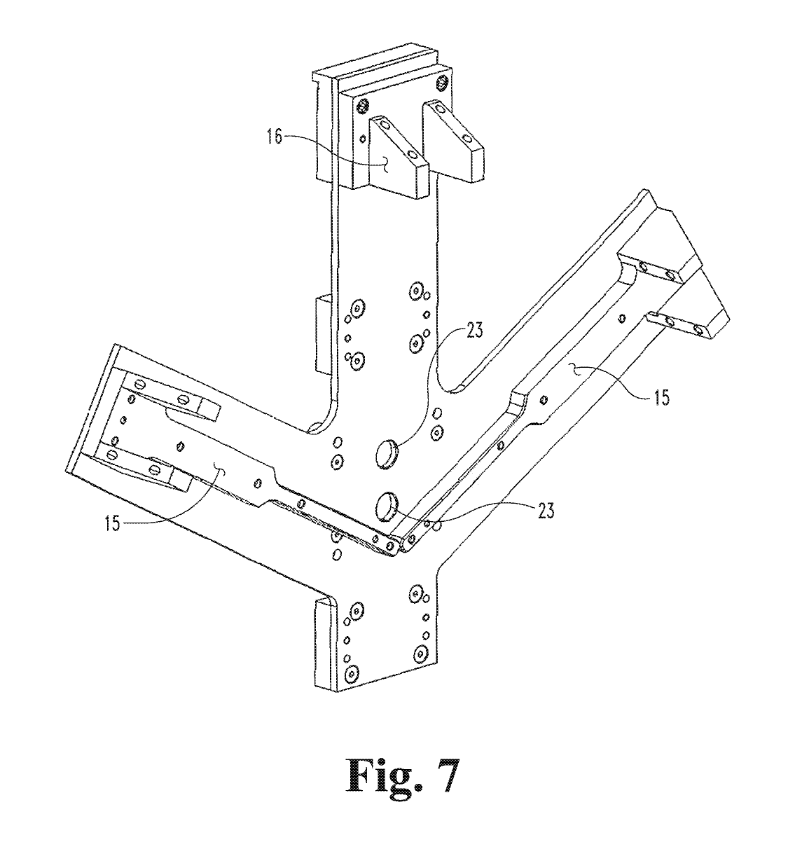

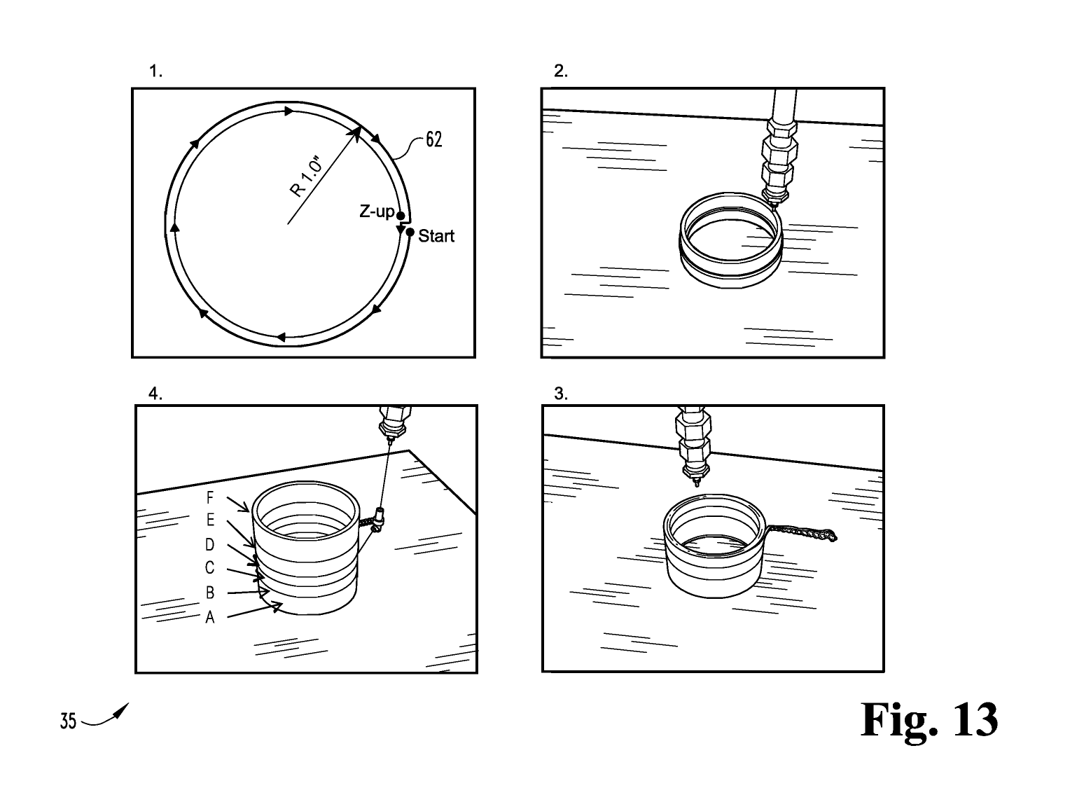

Referring to the drawings FIGS. 1-15 illustrate a first embodiment multi-extruder apparatus 100 of the present novel technology. FIG. 1 illustrates an overall view of the multi-extruder apparatus 100 for making three-dimensional functionally gradient composite parts. The gantry system 2 (multi-axis computer controlled extruder with a gantry structure) consists of four slides 30 and carries extrusion mechanism 3. This system 2 is built on a support frame 1. The support frame 1 also provides the references for the movements along the three Cartesian axes (X, Y and Z). The extrusion mechanism 3 is typically mounted on the gantry system 2 through mounting plate 24.

Mounting plate 24 holds linear positioners 12 and syringe housing 4. Bracket shoulder 18 assists in mounting the mixing station 31 on the slide 30 on the z-axis. Upper and lower spacers 19, 21 help to mount the plate 24 to the vertical slide (along the z-axis). Mounting brackets 20 connect the syringe housings 4. Linear positioners 12 are mounted on the plate 24 using support brackets 15, 16. Linear positioners 12 are each typically able to generate sufficient force to actuate the extrusion process. One function of the linear positioners 12 is to control the quantity of the paste going into the mixing station 31 as well as the speed of extrusion. The X-axis is controlled by two servo-motors 25 which typically run in parallel (i.e., in hydraulic communication with each other). Each of the y and z axes typically has its own servo-motor 25.

Housing 4 sits on mounting plate 24 being guided by holes 23 and mounted by fasteners 22, such as screws, bolts or the like. The housing 4 holds three stainless steel syringes 5 and a static stainless steel mixer 9. A plurality of typically stainless steel syringes 5 allow preparing a plurality of separate pastes on different syringes 5 and mounting the syringes 5 on the housing 4, such as by compressing o-rings 7 using the holding plates 6.

The multi-extruder machine 3 includes a two-stage mixing station 31 for mixing the three pastes 32 which come out of the respective syringes 5. The mixing is first done by merging pastes 32 into a homogeneous stream 53 as the different pastes 32 pass through the channels 27 that are positioned at different angles with respect to one another at the exits of the syringes 5. Due to this design of the mixer 9, a nearly homogeneous uniformity of the final part 37 can be obtained. The static mixer 9 typically features low shear, continuous in-line units which mix pastes 32 that can be pumped to the required consistency. Materials 33 to be mixed into pastes 32 include combinations of fluids, powders, granulars, and gases. The static mixer 9 typically requires no external power source. Alternately, dynamic mixer 9 may also be used instead of a static mixer 9 as required.

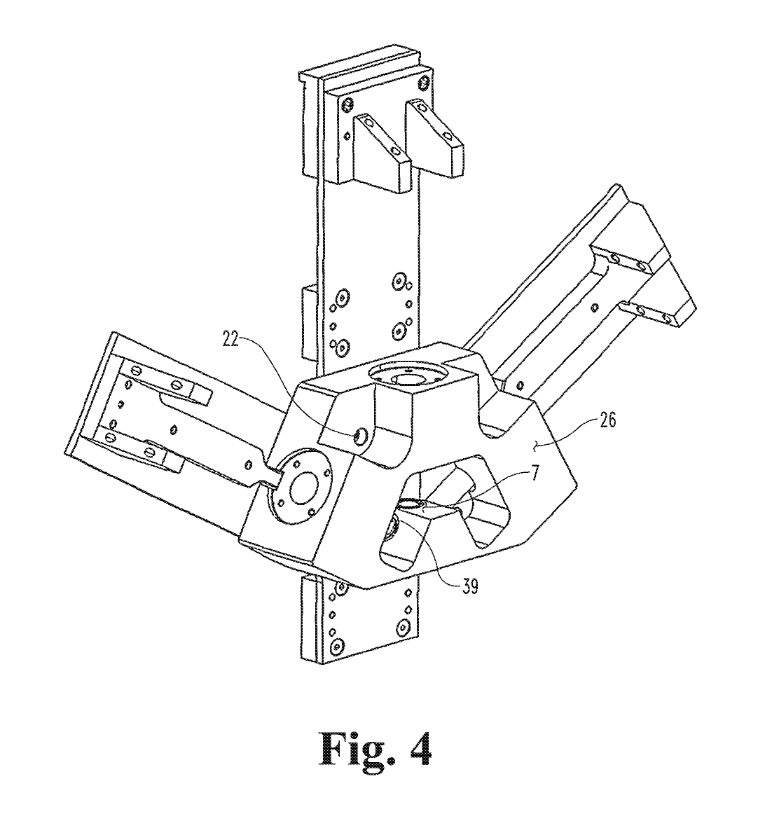

Static mixer 9 is typically mounted on the housing 4 through a flange 8. The sealing between the syringes 5 and the housing 4, as well as between the flange 8 and the housing 4 is provided by o-rings 7 made of elastomeric materials and, when compressed, react like a high viscosity fluid to transmit applied stress omnidirectionally. Consequently, the o-ring 7 serves as a barrier to block leak paths between sealing surfaces. The o-rings 7 typically exhibit excellent resistance to chemical products and solvents. The grooves 39 for the o-rings 7 can be seen in FIG. 4.

The connection between the static mixer 9 and the nozzle 11 is typically provided by an NPT adapter 10. The high pressure needle nozzle 11 is typically a nickel plated brass hub and, more typically, controls the thickness of the deposition layer.

Load cells 14 are located on the proximal ends of the piston rods. Load cells 14 enable control of pastes 32 during extrusion. Load cells 14 measure the amounts of applied force and provide the measured data to the control computer 42 to ensure that the forces are sufficient to extrude paste from the syringes 5. Load cells 14 are typically mounted on a flat support 13 using fasteners 43, such as cap screws, to secure to the base. A load button 44 allows for even distribution of force. Pushing support 17 links the load cell 14 and the syringe plunger 40.

The heat jacket 26 covers the housing 4 and the static mixer 9 to adjust the paste temperature to keep the paste 32 sufficiently warm inside the syringes 5 and the static mixing station 9 to prevent the pastes 32, 53 from freezing before exiting the nozzle 11.

### 1. Procedure for Manufacture of Functionally Graded Composite Parts

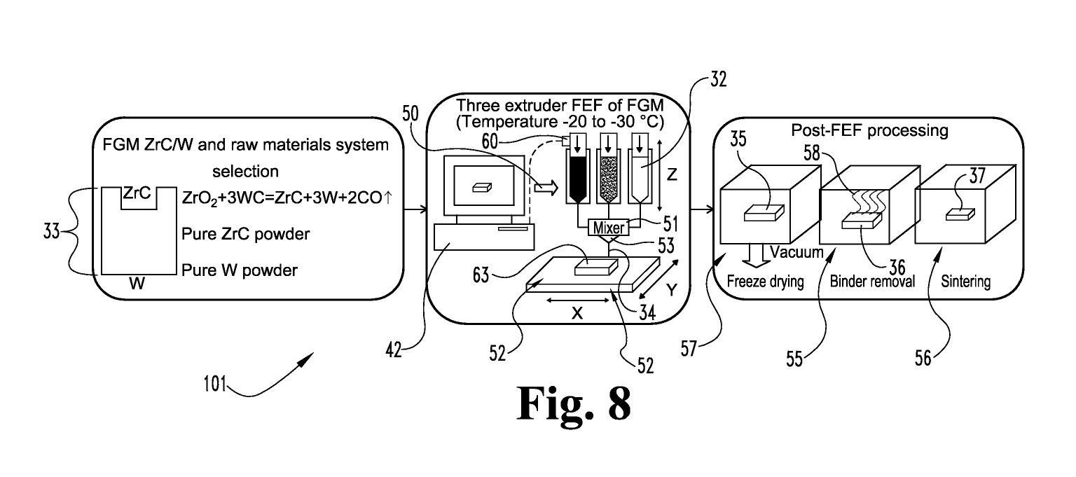

FIG. 8 shows the concept of fabricating a part 37 with gradient materials 33 using the FEF process 101. The FEF process 101 extrudes three different aqueous pastes 32 (in one example, made of WC+ZrO₂, pure W, and pure ZrC) at different rates continuously using computer control 50, mixing 51 these pastes 32 to yield an admixture 53, and depositing 52 the admixed paste 53 to build a “green” part 35 with continuous gradients 54 of materials 33. After binder burnout 55 and sintering 56 of the green part 35 built by the triple-extruder FEF system 100, the final part 37 has a gradient 54 from ZrC (which is a UHTC) to W (which is a refractory metal) as pre-specified. The fabricated green part 35 is then freeze-dried 57, and the binder 58 is removed through a burnout process 55 to produce a “brown” (binder pyrolyzed) part 36. The brown part 36 then undergoes sintering 56 to yield the final part 37, which has CAD dimensions and FGM compositions that are pre-specified.

### 2. Mechanical System

In the novel triple-extruder FEF process 101, up to three different pastes 32 can be prepared and transferred into the three respective syringes 5. It should be noted that although this specific example details a three extruder 5 system 100, other contemplated systems have more than three extruders. The syringes 5 are filled with pastes 32 and are placed in the housing fixture 4. The holding plates 6 are compressed against the o-rings 7 by tightening the mounting screws 22 to provide sealing of pastes 32 between the syringes 7 and the housing 4. Likewise, the flange 8 is compressed against another o-ring 7 to provide sealing of pastes 32 for the rest of the mechanism 3. Sealing between the static mixer 9 and the flange 8 is obtained by tightening the NPT adaptor 10 between them. An adapter 10 is used to mount a nozzle 11 at the end of the static mixer 9 for extruding the mixed paste 53. The housing 4 is typically covered by a heat jacket 26 to adjust and maintain the temperature of the pastes 32, 53 at the desired level for the extrusion process.

The guiding of the housing 4 to the mounting plate 24 is given by the two shoulders 18 on the back side. A plunger 40 is aligned with each syringe 5 and is mounted with a load cell 14 using an adapter 10. By controlling the force or speed of each plunger 40, and using a load cell 14 to measure the ram force 59 and an encoder 60 to measure the plunger position, the rate of paste extrusion from each syringe 5 may be controlled as desired. The pastes 32 from the three syringes 5 mix together first in the merge section of the channels 27 extended from the syringes 5 and then inside the static mixer 9, before going through the nozzle 11. The static mixer 9 ensures a good uniformity and homogeneity of the paste mixture 53. A dynamic mixer 9 may also be used if needed. The ratios of different pastes 32 may be changed continuously as needed, by changing the relative speeds of the different plungers 40, for fabricating a functionally graded composite part 37.

The extrusion assembly 3 is mounted on the gantry system 2, which allows control of nozzle 11 movement to any position at any velocity as desired. With the multi-extruder fabrication system 100, a 3D part of any complex geometry can be built layer by layer by using a computer software program to generate the paste deposition path 62 for each layer 63. The whole triple-extruder machine 100 may typically be placed inside a freezing chamber (not shown), and the temperature of the machine 3 may be adjusted by controlling the release of liquid nitrogen or the like, so as to freeze the paste 53 after the paste extrusion 52 on each layer 63 such that the bottom layers 63 can support subsequent layers 63, hence allowing fabrication of large parts 37 without deformation.

### 3. Control System

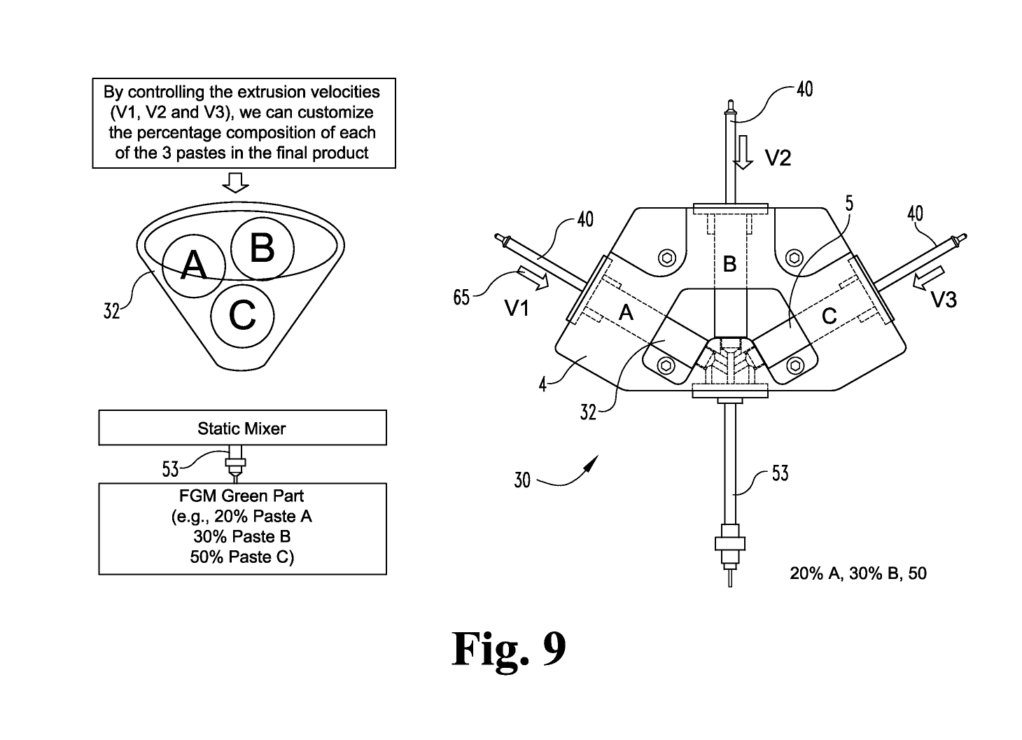

The material composition of the final part 37 may be determined by controlling the relative extrusion (plunger) velocities in the three syringes 5, as show in FIG. 9. Various control algorithms may be used to control the plunger 40 velocity for each syringe 5. In this feedback control system, the plunger dynamics for the extrusion 52 of paste 53 in each syringe 5 is modeled as

τ\dot{v}+v=Ku−f

where τ is the time constant, v is the plunger speed, K is the gain, u is the control voltage, and f is the friction. The model parameters may then be determined empricially using the servo motor voltage 64 as the input and the plunger speed 65 as the output.

### 4. Paste Preparation

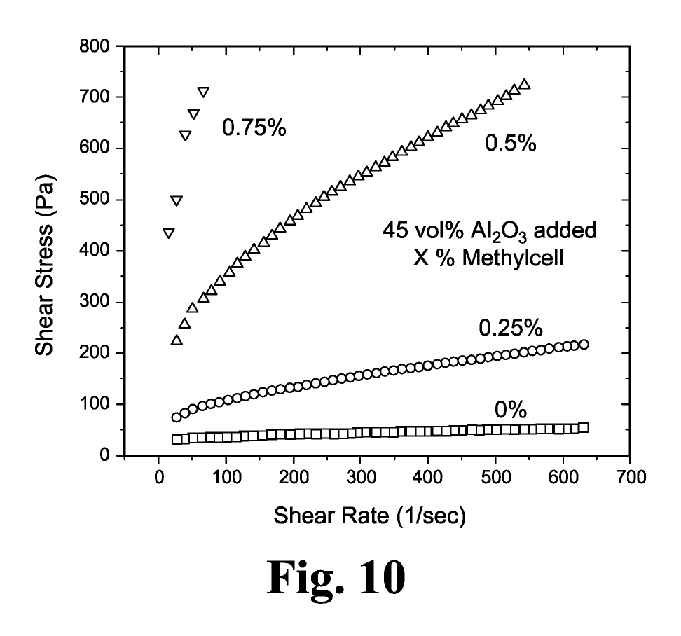

To fabricate a functionally graded composite part 37 using the triple extruder FEF machine 3, typically three different pastes 32 are used. In alternate systems, four or more pastes 32 may be combined. The respective pastes 32 typically each have an engineered composition and a predetermined rheological behavior in order for the mixed paste 53 to pass through a fine nozzle 11 to yield a 3D geometry layer-by-layer. It is desirable to use paste recipes that have high solids loadings, exhibit little or no phase separation under pressure, and behave like a pseudoplastic with a high yield stress. For example, Methycell is an efficient binder for transforming the rheological behavior of many pastes 32, 53 to exhibit pseudoplastic bebavior with a high yield stress, as shown in FIG. 10 for the Al₂O₃ paste 32. A controllable yield stress is helpful for the extrudate 35, 63 to maintain its shape under pressure during the paste extrusion process for fabricating the 3D part.

### 5. Implementation and Evaluation of the Inventive Freeze-Form Extrusion Fabrication Process

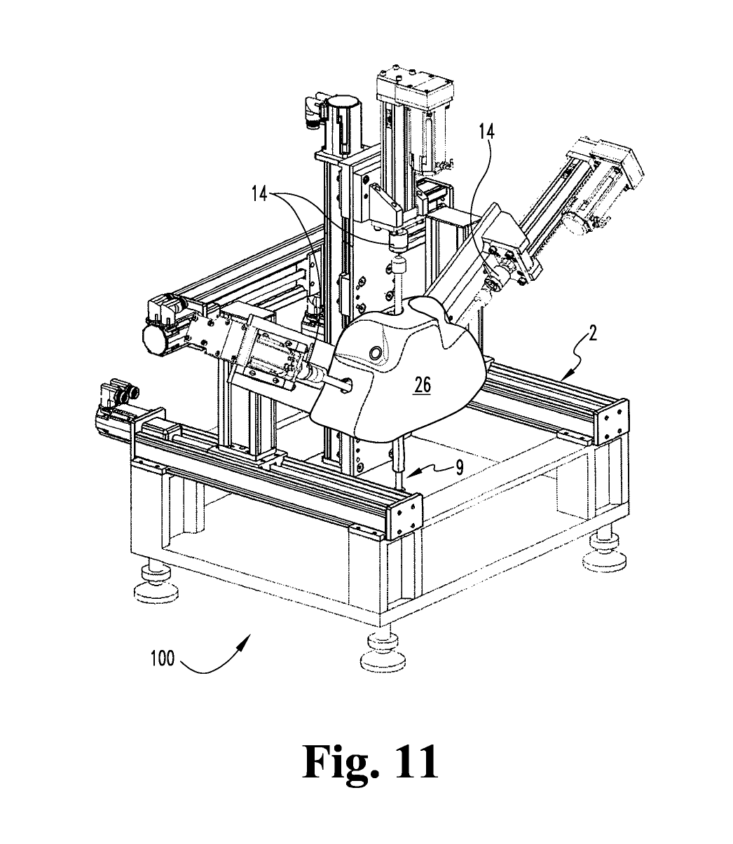

A triple-extruder FEF system 3 has been constructed as shown in FIG. 11. The FEF control system has been developed with a microprocessor 42. The 3-axis movement of the gantry system 2 is controlled by a motion control program running on the microprocessor 42. Extrusion 52 of pastes 53 is controlled with three servo motors 25.

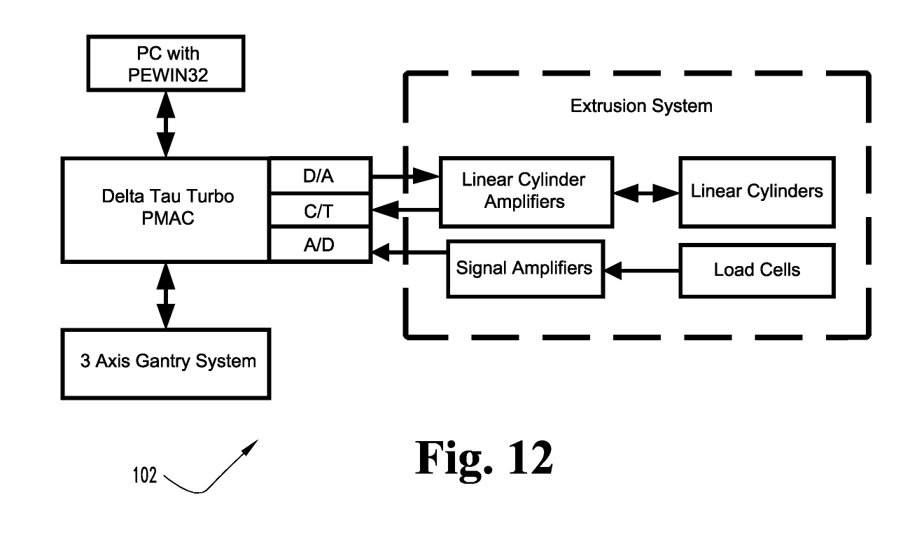

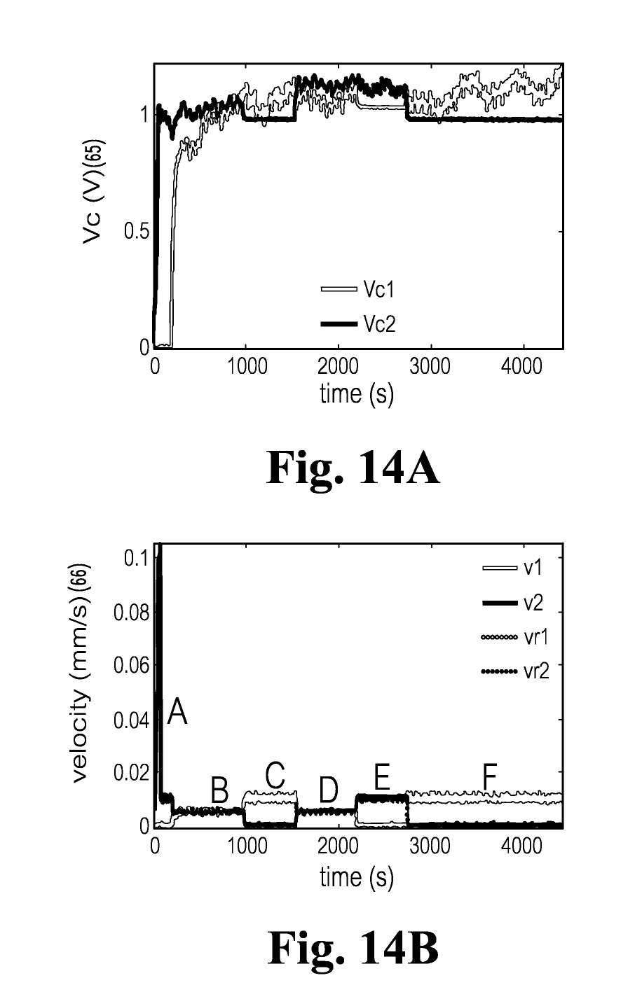

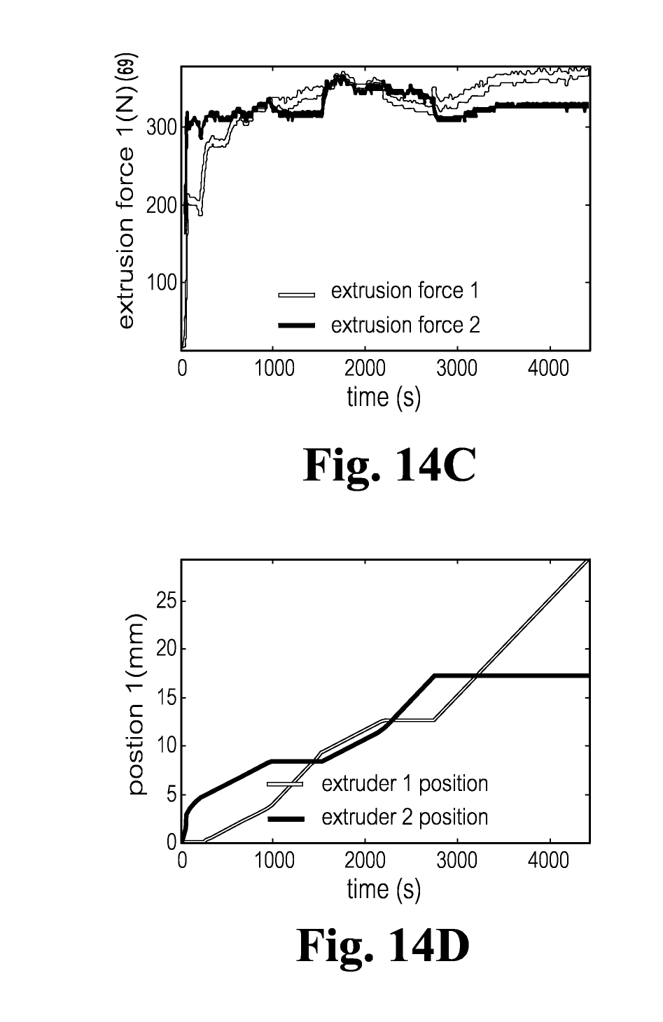

To test the capabilities of the FEF system 3 for building parts 37 with gradient materials 33 by varying extrusion velocities for different pastes 32, a cylindrical part 37 with a 50 mm diameter was fabricated with two extruders 5 filled with limestone (CaCO₃) pastes 32, one in green color and the other in pink color. The part 37 was built in an environment of −10° C. The fabrication result is shown in FIG. 12. The color of the fabricated cylinder part 37 starts in pink (A) and shifts to brown (B), then green (C), then brown (D), then pink (E), and finally green (F). The color distribution of the part 37 is consistent with the velocity profiles of the two extruders 5 shown in FIG. 14. In section A, only extruder one 5 was moving, which resulted in the pink color. When both extruders 5 are controlled to move at the same velocity, the extrudate becomes light brown, as shown in section B.

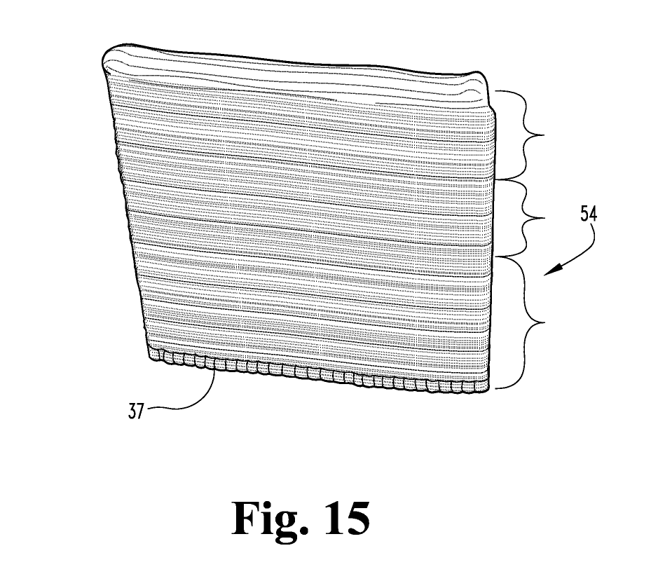

As another example, a vertical test bar (shown in FIG. 15) was produced using two pastes 32: paste A has 100% alumina (paste A) 32 and paste B 32 has 50% alumina and 50% zirconia. These tests were conducted again to ensure that the resulting paste mixture 53 after mixing pastes A and B 32 was of the correct composition. The part 37 was built with automatically generated velocity control to vary the composition from 100% paste A (100% Al₂O₃) 32 for the first 20 layers 63 to 50% paste A 32 and 50% of paste B (75% Al₂O₃ and 25% ZrO₂) 32 for the next 10 layers 63 and 100% paste B (50% Al₂O₃ and 50% ZrO₂) for the final 10 layers 63.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A freeze-form extrusion fabrication process for producing three-dimensional functionally gradient composite objects, comprising:
a) preparing a plurality of volumes of aqueous pastes, each respective paste having a very low organic binder content;
b) connecting at least three respective volumes of respective aqueous paste compositions in hydraulic communication with a mixing chamber;
c) extruding aqueous paste through the mixing chamber onto a target surface to define an extruded layer;
d) freezing the extruded layer immediately upon extrusion; and
e) stacking a plurality of frozen extruded layers to define an object.

2. The process of claim 1, wherein respective each paste composition has a solid loading of about 50 volume percent and an organic binder content of between about 2 volume percent and about 4 volume percent.

3. The process of claim 1 wherein each respective volume contains a different respective aqueous paste composition.

4. The process of claim 1 and further comprising:
f) mixing aqueous pastes of different compositions in the mixing chamber to yield a substantially homogeneous admixture.

5. The process of claim 1 and further comprising:
g) automatically mixing aqueous pastes of different compositions in the mixing chamber to yield a substantially homogeneous admixture by controlling the extrusion rates of the aqueous pastes;
wherein each respective volume is operationally connected to a respective plunger;
wherein each respective plunger is operationally connected to a respective servomotor;
wherein a microprocessor is operationally connected to each respective servomotor; and
wherein the microprocessor is programmed to control each respective servomotor to control the speed of each respective plunger to yield an admixture of predetermined composition.

6. The process of claim 1 and further comprising:
h) heating the mixing chamber.

7. The process of claim 1 wherein the mixing chamber further comprises:
a first portion operationally connected to each respective volume for receiving paste from each respective volume; and
a second portion operationally connected to the first portion for receiving and mixing paste from the first portion.

8. The process of claim 1 and further comprising:
i) generating a deposition path according to a predetermined geometric model of a desired object shape;
j) mixing pastes to define a first generally homogeneous paste admixture having a first composition;
k) automatically depositing the first paste admixture along the deposition path to define a first layer;
l) mixing pastes to define a second generally homogeneous paste admixture having a second composition different from the first composition; and
k) automatically depositing the second paste admixture along the deposition path to define a second layer.

9. The process of claim 1 wherein mixed paste in the mixing chamber has a compositional gradient and wherein the compositional gradient is generated by varying paste extrusion rates from the respective volumes.

10. An extrusion fabrication process for producing three-dimensional functionally gradient composite objects, comprising:
a) filling a plurality of syringes with a respective plurality of aqueous paste compositions, each respective paste composition having a very low organic binder content;
b) operationally connecting at least three respective syringes of respective aqueous paste compositions to a mixing chamber;
c) moving a first aqueous paste composition from a first respective syringe into the mixing chamber;
d) moving a second aqueous paste composition from a second respective syringe into the mixing chamber;
e) mixing the first and second aqueous paste compositions to define a first admixture having a first admixture composition;
extruding the first admixture onto a surface to define an extruded portion having a first admixture composition; and
g) freezing the extruded portion.

11. The process of claim 10 and further comprising:
h) mixing aqueous pastes to define a second admixture having a second admixture composition;
i) extruding the second admixture to define a second extruded portion having a second admixture composition, wherein the second extruded portion is contiguous with the first extruded portion;
j) freezing the second extruded portion;
k) extruding a plurality of respective portions, wherein each respective extruded portion is contiguous with at least one other respective extruded portion, to define an object.

12. An extrusion fabrication process for producing three-dimensional functionally gradient composite objects, comprising:
a) engaging a microprocessor to generate a deposition path according to a predetermined geometric model of a desired object shape;
b) filling a plurality of syringes with a respective plurality of aqueous paste compositions with low organic binder content, wherein each respective syringe includes a respective servomotor-actuated plunger to urge paste therefrom;
c) operationally connecting at least three respective syringes of respective aqueous paste compositions to a mixing chamber;
d) automatically moving a first combination of respective aqueous paste compositions from respective syringes into the mixing chamber;
e) mixing the first combination of respective aqueous paste compositions in the mixing chamber to define a first admixture having a first admixture composition;
f) automatically extruding the first admixture along the deposition path to define a first extruded portion having a first admixture composition;
g) automatically moving a second combination of respective aqueous paste compositions from respective syringes into the mixing chamber;
h) mixing the second combination of respective aqueous paste compositions in the mixing chamber to define a second admixture having a second admixture composition;
i) automatically extruding the second admixture along the deposition path to define a second extruded portion contiguous with the first extruded portion and having a second admixture composition;
j) repeating steps g through i a predetermined number of times to yield a three-dimensional functionally gradient composite object.
